(19) United States
(12) Patent Application Publication
(10) Pub. No.: US 2026/0163749 A1
(43) Pub. Date: Jun. 11, 2026

(54) Network Device Remote Login Profiles

(71) Applicant: Arista Networks, Inc., Santa Clara, CA (US)

(72) Inventors: Philip Bradish, Dublin (IE); Michelle Binlu Wang, Sunnyvale, CA (US); Hua Zhong, Los Altos, CA (US); Ethan Rahn, Agoura Hills, CA (US); Peter Edwards, Dublin (IE)

(21) Appl. No.: 18/976,146

(22) Filed: Dec. 10, 2024

(51) Int. Cl. H04L 9/32; H04L 9/40

(52) U.S. Cl. CPC H04L 9/3268; H04L 63/102

(57) ABSTRACT

A network device may maintain a login profile that facilitates remote login onto the network device by an accessing device using a user identity certificate. If desired, the login profile may identify a server-based certificate status check profile. If desired, the login profile may be usable with a domain name omit setting that determines the manner in which comparison between a login username and a subject name in the user identity certificate is performed.

### BACKGROUND

This generally relates to remote device access such as secure remote access of a network device by an accessing device.

In particular, a network can include network devices that convey network traffic from source devices to destination devices. It may be desirable for a user such as a network administrator operating a computing device to remotely access one or more of the network devices in the network in a secure manner, e.g., to perform device administration.

### BRIEF DESCRIPTION OF THE DRAWINGS

FIG. 1 is a diagram of an illustrative system for facilitating secure access of a network device in accordance with some embodiments.

FIG. 2 is a diagram of an illustrative user identity certificate in accordance with some embodiments.

FIG. 3 is a diagram of illustrative memory circuitry configured to store a domain name omit setting in accordance with some embodiments.

FIG. 4 is a diagram of an illustrative network device that handles a certificate-based login operation based on a domain name omit setting in accordance with some embodiments.

FIG. 5 is a diagram of illustrative memory circuitry configured to store a login profile in accordance with some embodiments.

FIG. 6 is a diagram of an illustrative network device that facilitates management of a login profile and/or a certificate status check profile in accordance with some embodiments.

FIG. 7 is a diagram of an illustrative network device that handles a certificate-based login operation based on login profile information in accordance with some embodiments.

FIG. 8 is a flowchart of illustrative operations for configuring a network device to handle a certificate-based login operation in accordance with some embodiments.

FIG. 9 is a flowchart of illustrative operations for validating a user identity certificate to authorize login onto a network device in accordance with some embodiments.

FIG. 10 is a diagram of an illustrative certificate status check profile containing an indication of a virtual routing and forwarding instance in accordance with some embodiments

### DETAILED DESCRIPTION

A network can convey network traffic, e.g., in the form of frames, packets, etc., between hosts. The hosts may be coupled to intervening network devices of the network that forward the network traffic. It may be desirable to provide mechanisms by which network devices can be accessed by network administrators or other authorized users, e.g., to perform network device administration functions such as network device management, network device configuration, network device operational data access, etc. As an example, a user computing device serving as the accessing device may perform a login operation to log onto and gain access to a target network device. This may be facilitated by client-side and server-side secure shell protocol (SSH) applications executing on the accessing device and the target device, respectively, as one illustrative example.

To enhance security and/or facilitate ease of login credential management for network device access, it may be desirable to use user identity certificates (e.g., public key infrastructure (PKI) or public key certificates such as X.509 certificates) to perform the login operation onto the network device to gain access. To appropriately handle this type of certificate-based login operation, the network device may be configured to maintain a login profile having a number of attributes for, among other functions, validating the user identity certificate being used for the login operation. Details for providing the login profile, for validating the user identity certificate, and/or generally for handling a certificate-based login operation (e.g., including the use of a domain name omit setting, the use of a certificate status check profile, etc.) are further described herein.

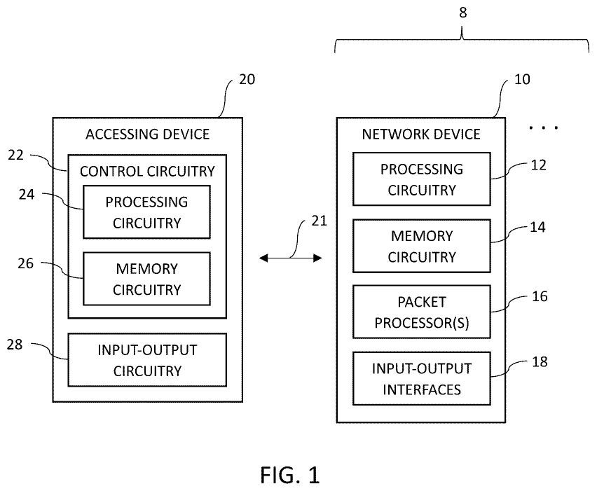

An illustrative networking system, in which certificate-based login operations may be used to gain access to network device(s), is shown in FIG. 1. In the example of FIG. 1, the networking system may include one or more components of a network such as network 8. Network 8 may have any suitable scope. As examples, network 8 may include, be, and/or form part of one or more local segments, one or more local area networks (LANs), one or more datacenter networks, one or more campus area networks, one or more metropolitan area networks, a wide area network, etc. Network 8 may include a wired network portion based on wired technologies or standards such as Ethernet (e.g., using copper cables and/or fiber optic cables) and, if desired, may include a wireless network portion such as one or more wireless local area networks (WLANs) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices that handle (e.g., process by switching, routing, forwarding, modifying, etc.) network traffic conveyed between devices (e.g., network devices and/or end host devices). In particular, network 8 may include networking equipment (e.g., network infrastructure hardware) forming a variety of network devices that interconnect end hosts of network 8. As examples, network devices of network 8 may include one or more switches (e.g., single-layer (Layer 2) switches, multi-layer (Layer 2 and Layer 3) switches, etc.), one or more routers, one or more gateways, one or more bridges, one or more hubs, one or more repeaters, one or more wireless access points, one or more firewalls, one or more devices serving other networking functions, one or more devices that include the functionality of two or more of these devices, and/or management equipment that manages and controls the operations of one or more other network devices. One such network device of network 8, network device 10, is shown in FIG. 1.

In the example of FIG. 1, illustrative network device 10 (e.g., a switch, a bridge, a router, etc.) may include processing circuitry 12, memory circuitry 14, one or more packet processors 16, and input-output interfaces 18 (e.g., network interfaces implemented on exterior-facing ports), among other components. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 12 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 12 may run (e.g., execute) a network device operating system and/or other software (including firmware) that is stored on memory circuitry 14. Memory circuitry 14 may include one or more non-transitory (tangible) computer-readable storage media that store the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 14). The corresponding processing circuitry (e.g., one or more processors of processing circuitry 12) may execute the respective instructions to perform the corresponding operations.

Memory circuitry 14 may include non-volatile memory device(s) (e.g., solid-state drives, flash memories or other electrically-programmable read-only memories, hard disk drive storage devices, etc.), volatile memory device(s) (e.g., static or dynamic random-access memories), removable storage device(s) (e.g., storage devices removably coupled to device 10), and/or other data storage circuitry. Processing circuitry 12 and memory circuitry 14 (e.g., at least some portions of both) may sometimes be referred to collectively as control circuitry (e.g., implementing a control plane of network device 10). Accordingly, processing circuitry 12 may sometimes be referred to as control plane processing circuitry 12.

In particular, processing circuitry 12 may execute network device control plane software such as operating system software, routing policy management software, routing protocol agents or processes, routing information base agents, and other control software, may be used to support the operation of protocol clients and/or servers (e.g., to form some or all of a communications protocol stack such as the Transmission Control Protocol (TCP) and Internet Protocol (IP) stack), may be used to support the operation of packet processor(s) 16, may store packet forwarding information, may execute packet processing software, and/or may execute other software instructions that control the functions of network device 10 and the other components therein.

Packet processor(s) 16 may be used to implement a data plane or forwarding plane of network device 10 and may therefore sometimes be referred to as data plane processor(s) 16 or data plane processing circuitry 16. Packet processor(s) 16 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 16 may receive incoming network packets via input-output interfaces 18 (and/or via device internal interfaces), parse and analyze the received network packets, process the packets based on packet forwarding decision data and/or in accordance with network protocol(s) or other traffic policy, and forward (or drop) the network packet accordingly.

To interact with external devices, external systems, and/or users, network device 10 may include input-output interfaces 18 formed from corresponding input-output devices (sometimes referred to as input-output circuitry or interface circuitry). Input-output interfaces 18 may include different types of communication interfaces such as Ethernet interfaces (e.g., formed from one or more Ethernet ports), optical interfaces (e.g., formed from optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, administrator devices, etc.).

As an example, some input-output interfaces 18 (e.g., those based on wired communications) may be implemented on physical ports. These physical ports may be configured to physically couple to and electrically connect to corresponding mating connectors of external components or equipment (e.g., cables, pluggable optical transceiver modules, etc.). Different ports may have different form-factors to accommodate different cables, different modules, different devices, or generally different external equipment. As another example, some input-output interfaces 18 (e.g., those based on wireless communications) may be implemented using wireless communications circuitry (e.g., antennas, transceivers, radios, etc.).

Network devices may be configured to support remote access (e.g., access through a network connection such as a portion of network 8) by other devices. In particular, a first device (sometimes referred to herein as an accessing device) may gain access to a second device (sometimes referred to herein as a target device) such as a network device. This may allow a user (e.g., a network administrator) operating the first device to remotely provide input to and/or remotely receive output from the second device. As shown in FIG. 1, an illustrative accessing device such as device 20 may be communicatively coupled to a target network device such as network device 10.

Accessing device 20 may access network device 10 by establishing a secure communication session (e.g., over one or more network paths 21 forming the network connection). In some illustrative arrangements sometimes described herein as an example, accessing device 20 may use the secure communication session to perform device administration of network device 10. As examples, accessing device 20 may use the secure communication session to supply device 10 with configuration data, control signals, and/or other networking information, to receive output such as performance metrics, log information, and/or other operational data from device 10, and/or to otherwise communicate with device 10 in order to perform other networking functions. Configurations in which the communication session between accessing device 20 and network device 10 is established using remote access protocols (e.g., a Secure Shell (SSH) protocol, remote login protocols, remote file transfer protocols, etc.) are sometimes described herein as examples. If desired, one or more intervening entities (e.g., proxy service(s) provided by server(s) or other entities) may help facilitate the establishment of the communication session between device 20 and device 10.

Accessing device 20 may be a computing device that includes control circuitry 22 having processing circuitry 24 and memory circuitry 26 and that includes input-output circuitry 28, among other components. Processing circuitry 24 may include one or more processors of any suitable type (e.g., CPUs, GPUs, microprocessors, general-purpose processors, host processors, microcontrollers, digital signal processors, programmable logic devices such as FPGA devices, ASSPs, ASIC processors, etc.).

Processing circuitry 24 may run a computing device operating system and/or other software (including firmware) that is stored on memory circuitry 26. Memory circuitry 26 may include one or more non-transitory (tangible) computer-readable storage media that store the operating system software and/or any other software code. As an example, the operations performed by device 20 to access network device 10 as described herein (e.g., operations performed by a client-side secure shell protocol application) may be stored as software instructions on the one or more non-transitory computer-readable storage media (e.g., in portion(s) of memory circuitry 26). The corresponding processing circuitry (e.g., one or more processors of processing circuitry 24) may process or execute the respective instructions to perform the operations for accessing device 10.

Memory circuitry 26 may include non-volatile memory device(s), volatile memory device(s), removable storage device(s), and/or other data storage circuitry. Processing circuitry 24 and memory circuitry 26 (e.g., at least some portions of both) may sometimes be referred to collectively as control circuitry 22. Control circuitry 22 may control the operation of other components such as components of input-output circuitry 28 (e.g., by outputting signals, commands, data, etc., to these components based on processing received signals, commands, data, etc.).

Input-output circuitry 28 may include one or more input-output devices configured to implement user interface(s) with which a user (e.g., a network administrator) can interact with device 20, e.g., by receiving user input and/or supplying the user with output (user output). As examples, the input-output devices may include a display (e.g., an integrated display or an external monitor), an integrated or external keyboard, an integrated or external touchpad or trackpad, a mouse, other types of keys, buttons, or wheels, and/or other devices configured to receive user input and/or supply user output. Input-output circuitry 28 may include interface circuitry through which internal components may interface and communicate with external equipment such as server(s), network device(s), and/or external device(s). As examples, the interface circuitry may include physical ports, wireless communication circuitry, encoders and/or decoders (e.g., that encode and/or decode data for conveyance across wired and/or wireless mediums), and/or other types of interface circuitry. While certain interface(s) are sometimes described to be provided by input-output circuitry 28, which is shown as being separate from control circuitry 22, this is merely illustrative. If desired, some portions of user interface(s) (e.g., those that are based on higher-level functions such as a graphical user interface for display) may be implemented by control circuitry 22.

Accessing device 20 may be implemented as any suitable type of computing device or equipment. As examples, device 20 may be a desktop computer, a laptop computer, a tablet computer, a cellular telephone, server-based (computing) equipment, a network controller or other type of network management device, or other types of computing devices. Configurations in which device 20 is a computing device operable by a network administrator are sometimes described herein as an illustrative example. Device 20 may therefore sometimes be referred to as a user device (or an administrator device).

Accessing device 20 may perform a remote login operation (e.g., by executing software instructions for a remote access application on processing circuitry 24) that is used to gain (administrative) access to network device 10. It may be desirable, e.g., from a security and/or ease of management perspective, to use certificates such as user identity certificates (e.g., public key certificates that include user identity information) as part of the authentication mechanism of the login operation. When appropriately configured, network device 10 may determine whether to authorize login of and to grant access to accessing device 20 based on the certificate information, among other login credentials. Once the login is authorized and access is granted to accessing device 20, the secure communication session between device 20 and device 10 may be established such that device 20 can control the operation of, or otherwise perform administrative-level interactions with, network device 10, as examples.

However, there may be challenges in providing network devices that appropriately facilitate the use of user identity certificates for login. As just a few examples, mismatches between certificate information and other user login credentials can lead to erroneous authentication failures, management of the necessary information at the network devices to provide the desired functionalities and/or to ensure accurate analysis of certificate validity can be challenging, etc. These challenges and the illustrative network device configurations that address these challenges and/or provide other advantages are further described herein.

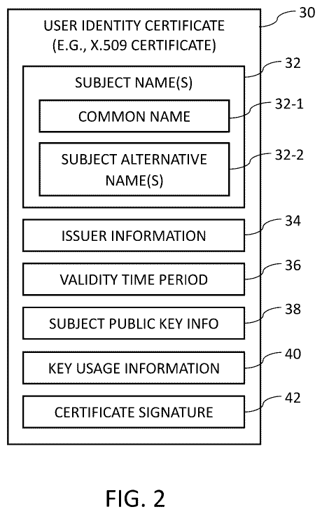

An illustrative example of a user identity certificate such as certificate 30 is shown in FIG. 2. Certificate 30 may be a digital certificate or a public key certificate that contains a public key of the entity, sometimes referred to as the subject, to which the certificate is issued (e.g., the user whose identity is to be authenticated) and that is cryptographically linked (e.g., by public-private key pairs of each certificate entity and corresponding digital certificate signatures) to the certificate-issuing entity (e.g., a certificate authority). Configurations in which user identity certificates (e.g., certificate 30) are implemented using PKI-based certificates, or more specifically, X.509 certificates (e.g., compliant or otherwise compatible with the International Telecommunications Union (ITU) X.509 standard) are sometimes described herein as examples. If desired, user identity certificates may be implemented using other types of (public key) certificates.

Some illustrative content contained in a user identity certificate is shown in the example of FIG. 2. In particular, user identity certificate 30 may include one or more subject names 32 such as a common name 32-1 and one or more subject alternative names 32-2. The subject may refer to the entity (e.g., user) to which certificate 30 is issued. Accordingly, a subject name 32 (e.g., common name 32-1 or any subject alternative name 32-2) may refer to a corresponding name associated with the user. As one illustrative example, common name 32-1 may be the primary user name and subject alternative name(s) 32-2 may be optional alternative user names. If desired, common name 32-1 and/or subject alternative name(s) 32-2 may be used in other (deployment-dependent) manners. Certificate 30 may include (certificate) issuer information 34 such as the certificate issuer's (e.g., the certificate authority's) common name and/or identifier, may include the identifier or location of the certificate issuer's (e.g., the certificate authority's) certificate, etc. Certificate 30 may include a validity time period 36 which provides information specifying when certificate 30 is valid (e.g., a time before which certificate 30 is valid and/or a time after which certificate 30 is valid). Certificate 30 may include subject (e.g., user) public key information 38 such as a public key encryption algorithm and the user's public key. Certificate 30 may include key usage information 40 which provides information specifying the appropriate or intended use(s) and/or application(s) of certificate 30 (e.g., information 40 may specify that certificate 30 is for client authentication). Certificate 30 may include a certificate signature 42 (signed by the issuer's private key) that provides the cryptographic link to other (indirectly or inherently trusted) certificate(s) in a certificate chain starting with certificate 30.

The information shown in certificate 30 of FIG. 2 is merely illustrative. Certificate 30 may include other types of information, if desired. As just a few examples, certificate 30 may include information such the version of the (X.509) standard applied to the certificate, the unique serial number provided by the certificate issuer for identifying the certificate, the cryptographic signing algorithm used by the certificate issuer to sign the certificate thereby generating signature 42, etc.

In the context of using a user identity certificate such as certificate 30 to perform a login operation onto a target network device, certificate 30 may be supplied along with a login username, as a pair of login credentials. However, even in scenarios where the user to which certificate 30 is issued is the user associated with the login username, extraneous information (e.g., information extraneous in this context) in the subject name of certificate 30 such as a domain name may interfere with appropriately matching the login username with the login certificate subject name. Accordingly, a network device may be configurable to maintain and selectively enable one or more settings to account for the presence of the extraneous information.

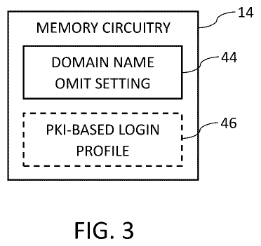

As shown in the example of FIG. 3, memory circuitry 14 of network device 10 (FIG. 1) may store information for a domain name omit setting 44. In particular, the stored information for setting 44 may be an indication of setting 44 being enabled or an indication of setting 44 being disabled. As an example, the indications of setting 44 being enabled or disabled may be provided by a flag, e.g., which when set indicates that setting 44 is enabled and which when cleared indicates that setting 44 is disabled, or vice versa. If desired, other indications of setting 44 being enabled or disabled may be used (e.g., a parameter having first and second values to indicate an enabled state and disabled state, respectively).

Setting 44 being enabled may facilitate verification of login credentials that takes into consideration and omits (e.g., ignores) an extraneous domain name in the certificate subject name(s) that might otherwise not match a login username. Setting 44 being disabled may facilitate verification of login credentials without this consideration. While a setting 44 for considering the domain name as extraneous information in the certificate subject name for login verification is described herein, this example is merely illustrative. If desired, other setting(s) in addition to or instead of setting 44 may be used in consideration of other types of extraneous information in the certificate subject name for login verification.

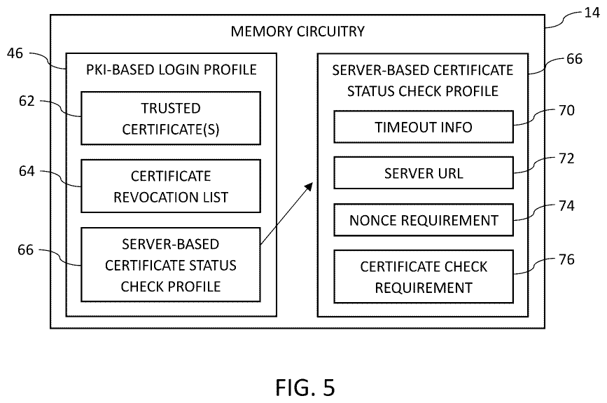

Because setting 44 is generally used in connection with a login operation onto a network device (e.g., device 10 in FIG. 1) using a certificate such as certificate 30 (FIG. 2), setting 44 may be applied as part of the login verification process and may be used in conjunction with a login profile such as PKI-based login profile 46 (e.g., described further in connection with FIG. 5) as part of the login verification process. In other words, a remote login process (e.g., executed as part of a server-side remote access application) may apply setting 44 (and if applicable, a login profile such as profile 46) to facilitate the login operation by accessing device 20 onto network device 10 (FIG. 1). As desired, setting 44 may be maintained and managed separately from profile 46, may be a globally applicable setting applied across profile(s) 46 generally for independent use with the remote login process, may be associated with and identified (or referenced) by profile 46, and/or may be included and managed within profile 46 (e.g., as an attribute of profile 46). In some instances, setting 44 may be applied to and used for certificate-based login verification even in the absence of login profile 46.

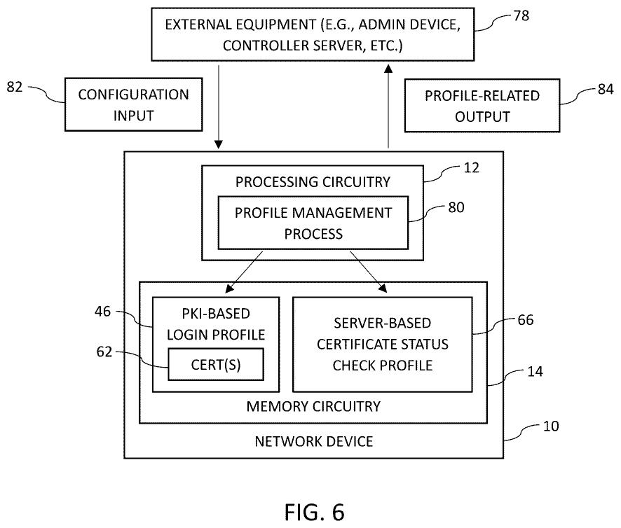

In general, processing circuitry 12 (FIG. 1) of device 10 may manage the state of setting 44 (e.g., switch setting 44 between enabled and disabled states) based on received configuration input for network device 10, e.g., as further described below in connection with FIG. 6, may provide a default (enabled or disabled) state for setting 44 (e.g., that is generally applicable, or if desired, as a (same or different) profile-specific default state for each login profile 46, if multiple are present, etc.), may provide output to indicate the current state of setting 44, e.g., as further described below in connection with FIG. 6, etc.

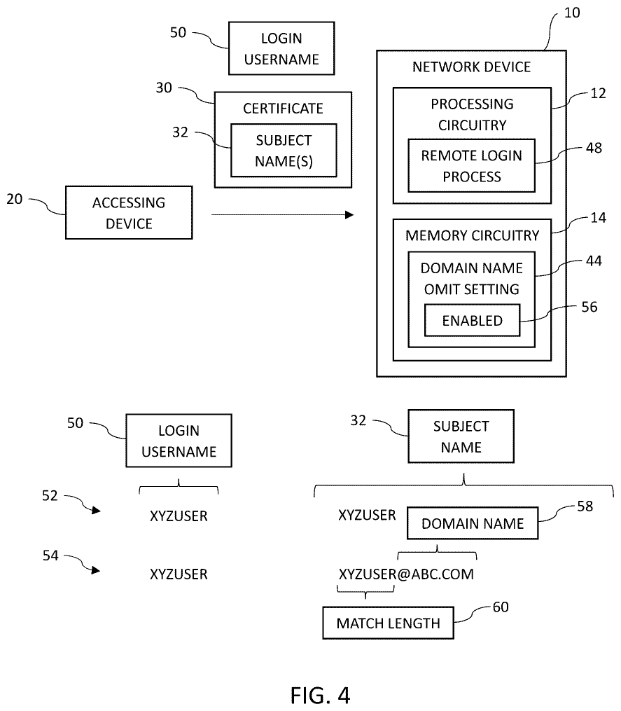

FIG. 4 is a diagram of an illustrative network device (e.g., network device 10 in FIG. 1) configured to handle a login operation based on a domain name omit setting (e.g., setting 44 as described above in connection with FIG. 3). In the example of FIG. 4, setting 44 stores an indication 56 of setting 44 being in an enabled state. Based on setting 44 being enabled, verification of login credentials may consider domain name in any received certificate subject name(s) as extraneous information for the purposes of matching to other user name information (e.g., a login username).

In particular, processing circuitry 12 may run software instructions (e.g., stored on memory circuitry 14) for executing a remote login process 48 (sometimes referred to as a remote login agent 48) which can be implemented as part of a remote access application (e.g., a server-side secure shell protocol application). Processing circuitry 12, when executing process 48, may facilitate the reception, processing, authorization (or denial), and/or other handling of login attempts or login operations by one or more accessing devices such as device 20 onto network device 10 (e.g., to gain administrative access to device 10). In the illustrative example of FIG. 4, processing circuitry 12 may execute software instructions for process 48 to determine (e.g., verify) whether a login username matches any of the subject name(s) in a login certificate. While a remote login process 48 is sometimes described herein to perform the operations for handling login attempts, this is merely illustrative. Processing circuitry 12 may be organized and configured in any suitable manner (e.g., to execute any other processes or agents instead of or in addition to process 48) to perform each part of these operations. Accordingly, processing circuitry 12 may sometimes be described herein to perform these operations instead of specifically referring to the one or more agents, processes, and/or kernel executed by and implemented on processing circuitry 12.

As shown in FIG. 4, network device 10 (e.g., processing circuitry 12 thereof, when executing process 48) may receive or otherwise obtain, from accessing device 20, login credentials in connection with a login attempt to gain (administrative) access to device 10. In particular, the login credentials received by processing circuitry 12 may include a login username 50 and a login certificate 30 (e.g., an instance of user identity certificate 30 in FIG. 2).

As part of the process for verifying the login credentials associated with the login attempt, processing circuitry 12 may compare login username 50 to subject name(s) 32 in certificate 30 (e.g., to the common name 32-1 and to any subject alternative name(s) 32-2 in certificate 30 as described in connection with FIG. 2) to verify that the user, to which certificate 30 is assigned and whose identity certificate 30 can authenticate (e.g., as indicated by subject name(s) 32), matches the user logging in (e.g., as indicated by username 50).

When this comparison between username 50 and each of certificate subject name(s) 32 is performed without setting 44 (e.g., with setting 44 being disabled or in the absence of setting 44), an exact match between username 50 and (at least) one of the subject name(s) 32 (e.g., a character-to-character match across the entire name length, which needs to be the same between username 50 and the subject name 32 for a match) is required to verify that certificate 30 can authenticate the user identity of the user logging in. FIG. 4 shows an example of an illustrative scenario 52 in which a login username 50 of “XYZUSER” is received by processing circuitry 12 and a subject name 32 of “XYZUSER” in certificate 30 is received by processing circuitry 12. Without setting 44, processing circuitry 12 may determine, in scenario 52, that the received login username 50 matches (e.g., by exact match) the subject name 32 in the received certificate 30.

However, due to the origination process of certificates (e.g., PKI certificates) and/or by convention, a certificate subject name can often include a domain name (e.g., following the user name), while a login username often does not include a domain name (e.g., by convention, because the login username may be domain-generic or domain-independent, etc.). As such, this mismatch caused by the presence and absence of the domain name can lead to an inadvertent determination of a failure to match a certificate subject name to the login username, even when both refer to the same user.

FIG. 4 shows an example of another illustrative scenario 54 in which a login username 50 of “XYZUSER” is received by processing circuitry 12 and a subject name 32 of “XYZUSER@ABC.COM” in certificate 30 is received by processing circuitry 12. Without setting 44, processing circuitry 12 may determine, in scenario 54, that the received login username 50 does not match (e.g., is not an exact match with) the subject name 32 in the received certificate 30 due to the excess domain name (portion) 58 (e.g., “@ABC.COM”) in the received subject name 32.

Accordingly, in anticipation of this type of undesired mismatch determination, processing circuitry 12 may configure domain name omit setting 44 to be in an enabled state (e.g., by default as a default state, based on configuration and/or user input, etc.). With setting 44 enabled, processing circuitry 12 may identify any subject name 32 including a domain name 58 and may obtain, for each subject name 32 including a domain name 58, an effective subject name length 60 that is less than the entire (total) length of the subject name and that is equal to the entire (total) length of the login username 50. In other words, the effective subject name length excludes (the length of) domain name 58. For the comparison between login username 50 and a subject name 32, processing circuitry 12 may compare login username 50 to the subject name 32 (that includes a domain name 58) over only characters in length 60 (starting from the first character) to determine whether there is an exact match and consequently whether login certificate 30 can be used to authenticate a login attempt using login username 50. Accordingly, because the effective length 60 excluding domain name 58 is used for this type of comparison or matching, length 60 may sometimes be referred to as a match length 60.

When applied to the illustrative scenario 54 in FIG. 4 (with setting 44 is enabled), processing circuitry 12 may determine that match length 60 of the subject name 32 is seven characters (e.g., defined by the number of characters up to the “@” character, which is the same as the length of seven characters in login username 50, in this example) and may perform an exact match comparison across the seven characters of the login username 50 and the first seven characters of the subject name 32, while ignoring or omitting consideration of any domain name characters (e.g., “@ABC.COM”) that follow the characters in the match length 60. In other words, processing circuitry 12 may identify the “@” character in any subject name 32 and consider the characters from the first character up to (e.g., but not including) the “@” character as part of the match length 60. In instances where a subject name 32 includes multiple “@” characters, processing circuitry 12 may identify the last “@” character and consider the characters from the first character up to the last “@” character as part of the match length 60 (e.g., the match length 60 may include one or more prior “@” characters). This results in a comparison between the login username 50 of “XYZUSER” and the first set of match length characters of “XYZUSER” in the subject name 32. Accordingly, processing circuitry 12 may determine that there is a match between the login username 50 and the subject name 32 even in scenario 54 (with setting 44 enabled).

Configured in this manner, even when domain names are included in certificate subject names 32 (e.g., in common name 32-1 and/or subject alternative name(s) 32-2) in certificate 30, processing circuitry 12 may still appropriately match login username 50 to the appropriate portion (e.g., characters in match length 60) of subject names 32 to determine whether login certificate 30 can be used to authenticate a login attempt by login username 50.

In general, efficiently managing information for handling certificate-based login attempts at network devices can be challenging. If care is not taken, unauthorized access may be inadvertently permitted, compromising the security of the network. In illustrative configurations described herein as an example, a network device may maintain a login profile containing information usable to facilitate validation of certificates for permitting the authorized login onto and the subsequent access of the network device by an accessing device. Because this type of login profile can be configured to perform login verification in numerous customizable ways, greater flexibility is provided to network administrator(s) in implementing their desired manner of login verification (e.g., using a customized login profile configuration implemented at the network device).

FIG. 5 is a diagram of an illustrative login profile such as PKI-based login profile 46 configured and maintained on a network device (e.g., stored on memory circuitry 14 of network device 10 in FIG. 1). Because login profile 46 may be used to facilitate a remote login operation (e.g., a login operation via a network connection to the network device), profile 46 may sometimes be referred to as a remote login profile. In particular, login profile 46 may include, identify (e.g., reference, include an indication of, etc.), and/or be generally associated with one or more attributes (sometimes referred to as login profile attributes) that define the configuration of login profile 46 and therefore login verification behavior, when profile 46 is applied.

In the example of FIG. 5, login profile attribute(s) include or reference indicate one or more trusted (PKI or public key) certificates 62. Certificate(s) 62 may include one or more inherently trusted root certificates and/or one or more indirectly trusted intermediate certificates. Certificate(s) 62 may form part of the certificate chain starting with a user identity certificate 30 (FIG. 2) and may be used to verify the authenticity of and establish trust in certificate 30 (e.g., used to perform a certificate chain verification for certificate 30 that verifies the certificate signatures of the certificate chain). Login profile attribute(s) may include or reference one or more certificate revocation lists 64 (e.g., database(s) of certificates that have been revoked or invalidated by the certificate issuer(s) or one or more certificate authorities, prior to the certificate's validity time period therein indicating invalidity). Login profile attributes(s) may include or reference certificate status check profiles such as a server-based certificate status check profile 66. In some illustrative configurations, attributes for certificate revocation list(s) 64 or certificate status check profile(s) 66 may be omitted from login profile 46. If desired, login profile attributes may also include or reference other profile-defining information, such as the domain name omit setting 44 in one illustrative example described in connection with FIG. 3.

A server-based certificate status check profile 66 may include, identify (e.g., reference, include an indication of, etc.), and/or be generally associated with one or more attributes (sometimes referred to as certificate status check profile attributes) that define the configuration of profile 66 and therefore the behavior for checking certificate status (e.g., certificate revocation status) when communicating with a remote server (e.g., using an online certificate status protocol (OCSP), with an OCSP server). In illustrative configurations where OCSP is used, server-based certificate status check profile 66 may sometimes be referred to as an OCSP profile. If desired, server-based certificate status check profile 66 may be configured, stored, and/or otherwise managed separately from login profile 46 but may be identified (e.g., referenced) and applied by login profile 46. If desired, a hybrid profile may include both login profile attributes and certificate status check profile attributes may be used.

As shown in the example of FIG. 5, some illustrative certificate status check attributes in profile 66 may include a timeout information attribute 70 (e.g., indicative of a time period for server response before a server request sent to the server is timed out, sometimes referred to as a server request timeout attribute), a server uniform resource locator (URL) attribute 72 (e.g., indicative of a location of the remote server that provides the certificate status check service, which if desired, overrides one or more certificate status check servers identified in certificate 30), a nonce (random or pseudo-random) value requirement attribute 74 (e.g., indicative of whether to send a nonce value in the request sent to the server and/or indicative of whether or not a nonce value is required in a response received from the server, etc.), and a certificate check requirement attribute 76 (e.g., indicative of the degree of certificate chain validation performed by the server, such as whether the entire certificate chain from certificate 30 up to the inherently trusted root certificate should be validated, whether only certificate 30 should be validated, or whether only certificates 30 that specify a certificate status check server therein should be validated by the specified server). If desired, certificate status check profile attributes may also include or reference other profile-defining information.

A login profile of the type shown in FIG. 5 may be configured (customized), by providing different attribute values, different types of attributes, etc., to exhibit different login attempt verification behaviors (e.g., certificate validation behaviors) depending on the needs of the deployment and/or the needs of the network administrator. FIG. 6 is a diagram of an illustrative network device (e.g., network device 10 in FIG. 1) that provides mechanisms for configuring a login profile such as login profile 46 and, if desired, a server-based certificate status check profile 66.

In particular, processing circuitry 12 of device 10 may run software instructions (e.g., stored on memory circuitry 14) for executing a profile management process 80 (sometimes referred to as a profile management agent 80). Processing circuitry 12, when executing process 80, may facilitate the management of profile(s), such as remote login profile 46 and/or remote server-based certificate status check profile 66, that handle remote certificate-based login onto network device 10. As examples, the profile management operations performed when executing process 80 may include the reception of configuration input based on which profile(s) are generated, updated, and/or deleted, the generation, updating, and deletion of profile(s), the output of information based on the currently maintained or stored profile(s). While a profile management process 80 is sometimes described herein to perform the management of profile(s) associated with remote login handling, this is merely illustrative. Processing circuitry 12 may be organized and configured in any suitable manner (e.g., to execute any other processes or agents instead of or in addition to process 80) to perform each part of these operations. Accordingly, processing circuitry 12 may sometimes be described herein to perform these operations instead of specifically referring to the one or more agents, processes, and/or kernel executed by and implemented on processing circuitry 12.

As shown in the example of FIG. 6, network device 10 (e.g., processing circuitry 12 when executing process 80) may interact with external equipment 78 (e.g., communicate with external equipment 78, by exchanging messages over a communication link implemented using paths through network 8 in FIG. 1) to receive a desired configuration for profiles 46 and/or 66 (and if desired, for setting 44 in FIG. 3). External equipment 78 may be any suitable computing equipment having administrative access to network device 10 such as an administrator-operated device (e.g., the same device 20 as in FIG. 1 or a different administrator device), a controller server (e.g., a server that provides a device or network management service or platform), etc.

In particular, processing circuitry 12 may receive, from external equipment 78, input 82 indicative of profile configurations (sometimes referred to as configuration input 82). Based on the received input 82, processing circuitry 12 may appropriately configure login profile 46 and/or certificate status check profile 66, including an association therebetween (e.g., configure profile 46 to indicate or otherwise reference a profile 66 to be applied when profile 46 is used).

In general, configuration input 82 may contain information indicative of a profile configuration modifies a default or existing configuration for these profile(s), may contain information indicative of default or customized configurations for generating new profile(s), may contain information for associating profiles with each other (e.g., associate a login profile with a certificate status check profile), etc. As examples, configuration input 82 may include or otherwise identify one or more trusted certificates 62 or certificate locations from which certificates 62 can be obtained and one or more certificate revocation lists 64 (FIG. 5) or location(s) from which list(s) 64 can be obtained. If desired, configuration input 82 may include or otherwise provide an indication for a domain name omit setting 44 in FIG. 3 (e.g., that places setting 44 in an enabled or disabled state). As further examples, when certificate status check profile 66 is specified, configuration input 82 may include a time value for the timeout information attribute 70, a URL for a certificate status check server for the server URL attribute 72, an indication of whether a nonce value is required or optional in the server response for the nonce value requirement attribute 74, and an indication of the degree of certificate validation desired from the certificate status check server for the certificate check requirement 76.

If desired, processing circuitry 12 may also provide output 84 containing (login and/or certificate status check) profile-related information (e.g., current profile configuration, configuration errors based on received configuration input 82, etc.) to external equipment 78. As an example, when an inappropriate combination of information for configuration input 82 is received and/or when (critical) information is missing from configuration input 82, processing circuitry 12 may convey an indication (e.g., a message) of configuration error as output 84 to external equipment 78. As another example, when requested by external equipment 78 (or in other scenarios, such as when the desired configuration indicated by input 82 has been successfully configured on device 10), processing circuitry 12 may present one or more (e.g., all) of the implemented configuration information specified in login profile 46 and/or certificate status check profile 66 to external equipment 78, e.g., for presentation to the user, confirmation by the user, for logging by a management service, etc.

In some illustrative configurations described herein as an example, configuration input 82 and profile-related output 84 may be provided via a command line interface implemented (at least in part) by processing circuitry 12. If desired, input 82 may be received and output may be provided in other manners. For example, input 82 may be received as a configuration file, output can be in the form of a report file containing log information recorded by processing circuitry 12, etc. If desired, other types of interfaces such as application programming interfaces (e.g., provided by corresponding processes or agents executing on processing circuitry 12) may be used to facilitate communication of input and output information between network device 10 and external equipment 78.

After providing the desired configuration input to (and/or keeping at least some or all the default configuration of) remote login profile 46 and/or server-based certificate status check profile 66, network device 10, with the appropriately configured profile(s) stored on memory circuitry 14, may be configured to handle login operations by an accessing device 20 that provide certificates such as user identity certificate 30 (FIG. 2).

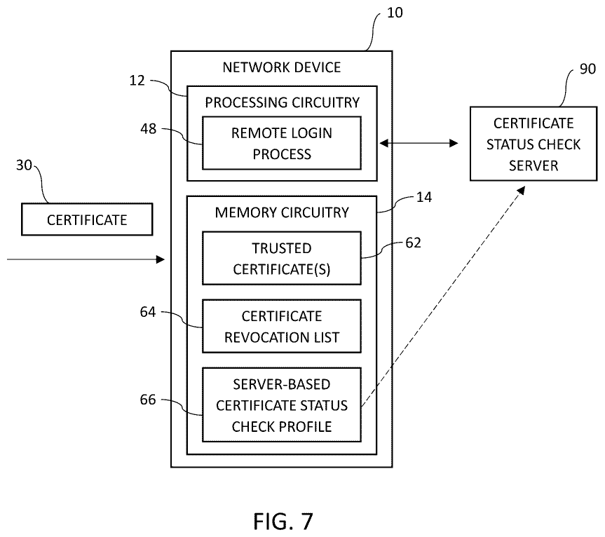

FIG. 7 is a diagram of an illustrative network device (e.g., network device 10 in FIG. 1) configured to facilitate a login operation based on remote login profile information (e.g., information in or otherwise identified by login profile 46 in FIG. 5). In illustrative configurations sometimes described herein as an example, processing circuitry 12, when executing software instructions for remote login process 48 (e.g., the same process 48 described in connection with FIG. 4, such as a process for a server-side secure shell protocol application), may perform operations for login certificate validation and for other parts of login verification based on the login profile information. Processing circuitry 12 may be organized and configured in any suitable manner (e.g., to execute any other processes or agents instead of or in addition to process 48) to perform each part of these operations. Accordingly, processing circuitry 12 may sometimes be described herein to perform these operations instead of specifically referring to the one or more agents, processes, and/or kernel executed by and implemented on processing circuitry 12.

Processing circuitry 12 may receive certificate 30 as part of login credentials (along with a login username) in connection with a login attempt by an accessing device 20, as described in connection with FIG. 4. Processing circuitry 12 may validate login certificate 30 to verify login (e.g., verify login credentials) and determine whether login to be authorized.

As part of the certificate validation process, processing circuitry 12 may verify that the PKI certificate chain including the received login certificate 30 and trusted certificate(s) 62, e.g., identified by login profile 46, (and/or if desired, other remote certificates) to verify the authenticity of certificate 30. The certificate chain verification may start with the received login user identity certificate 30 and end with the root (trusted) certificate (with optional intermediate certificate(s) therebetween). In particular, processing circuitry 12, as part of the validation process, may verify that each certificate in the chain has a certificate signature signed using the private key of the subject of the preceding certificate, until the last root certificate, which has a certificate signature that is self-signed. These intermediate and/or root certificate(s) may be stored as trusted certificate(s) 62 in or otherwise identified by profile 46 (FIG. 5). If desired, some of these intermediate and/or root certificate(s) may be obtained based on corresponding indications in the received certificate 60, may be obtained directly from accessing device 20, and/or may be obtained dynamically upon receiving certificate 30 for validation.

Further, as part of the certificate validation process, processing circuitry 12 may determine (e.g., verify) that the login certificate 30 has not been revoked or invalidated by using locally maintained certificate revocation list(s) 64 and/or using a certificate status check server 90. When using list(s) 64 to determine validity of login certificate 30, processing circuitry 12 may compare login certificate 30 to each of the (revoked) certificated in list(s) 64 and determine whether there is a match. If a match is identified, processing circuitry 12 may determine that login certificate 30 has been revoked and is therefore invalid (even if certificate 30 indicates validity based on its validity time period). Processing circuitry 12 may deny the login onto device 10 based on the login certificate 30 being invalid.

When using a remote server such as server 90 to determine validity of login certificate 30, processing circuitry 12 may identify server 90 (e.g., the location of server 90), with which certificate status check (request and response) messages are exchanged, based on a server location identified in certificate status check profile 66 (e.g., in the server URL attribute 72 in FIG. 5) or based on a server location identified in received certificate 30. If desired, any certificate status check server identified in profile 66 overrides (e.g., is used instead of) certificate status check server(s) identified in certificate 30. When checking the certificate revocation status or generally the validity of login certificate 30, processing circuitry 12 may communicate with certificate status check server 90 in a manner specified by certificate status check profile 66 (e.g., a manner specified by a timeout information attribute 70 in FIG. 5, a nonce value requirement attribute 74 in FIG. 5, and/or a certificate check requirement attribute 76 in FIG. 5).

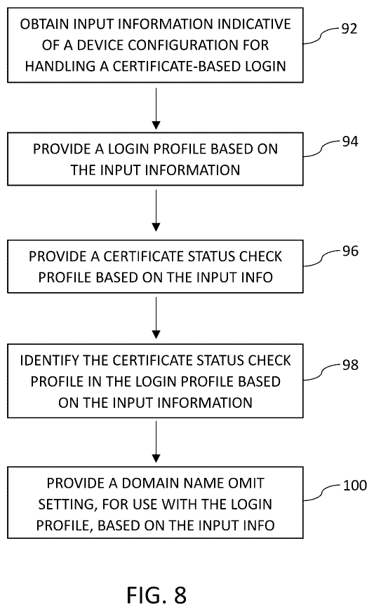

FIG. 8 is a flowchart of illustrative operations for configuring a network device to handle a remote user login operation using a login certificate (e.g., a PKI certificate containing user identity information). In particular, these operations may be performed by one or more processors of network device 10 (e.g., processing circuitry 12 in FIG. 1) using other components of network device 10 (e.g., memory circuitry 14, packet processor(s) 16, interfaces 18, etc., in FIG. 1). In some configurations described herein as an illustrative example, at least some of the operations described in connection with FIG. 8 may be performed by one or more processors (e.g., of processing circuitry 12) executing software instructions stored on memory circuitry (e.g., one or more non-transitory computer-readable storage media of memory circuitry 14). If desired, one or more operations described in connection with FIG. 8 may be performed in other manners by network device 10 or by other types of networking equipment.

At block 92, processing circuitry (e.g., processing circuitry 12, when executing the profile management process 80 in FIG. 6) may obtain input information indicative of a network device configuration for handling a certificate-based login (onto the network device). This type of input information may sometimes be referred to as device configuration input information or configuration input (e.g., configuration input 82 in FIG. 6).

At block 94, the processing circuitry may provide (e.g., generate) a login profile based on the input information. As an example, the input information may include login profile attributes, such as those described in connection with FIG. 5. Accordingly, the input information indicative of login profile attributes (e.g., values therein) may be used to provide the login profile, e.g., in the illustrative manner described in connection with FIG. 6.

At block 96, the processing circuitry may provide (e.g., generate) a certificate status check profile based on the input information. As an example, the input information may include certificate status check profile attributes, such as those described in connection with FIG. 5. Accordingly, the input information indicative of certificate status check profile attributes (e.g., values therein) may be used to provide the certificate status check profile, e.g., in the illustrative manner described in connection with FIG. 6.

At block 98, the processing circuitry may identify (e.g., stored an indication of) the certificate status check profile in the login profile based on the input information. As part of the configuration for login profile (e.g., as part of a login profile attribute as described in connection with FIG. 5), the certificate status check profile (or an indication thereof) may be specified. This type of association between the certificate status check profile and the login profile (e.g., shown in the example of FIG. 5) may be specified in the input information, e.g., in the illustrative manner described in connection with FIG. 6.

At block 100, the processing circuitry may provide a domain name omit setting, for use with the login profile, based on the input information. As described in connection with FIG. 6, configuration input information may specify a state of the domain name omit setting. The domain name omit setting may be configured and maintained in the manner described in connection with FIG. 3 (e.g., as a setting separate from but usable with login profile 46, or if desired, as an attribute of profile 46).

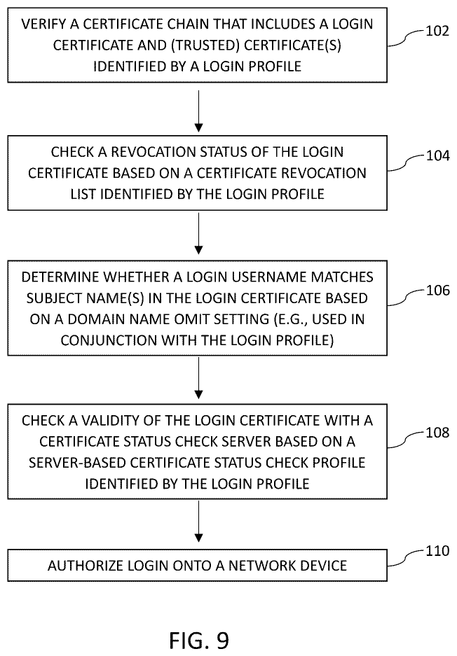

FIG. 9 is a flowchart of illustrative operations for operating a network device to handle a remote login operation using a login certificate (e.g., a PKI certificate containing user identity information). In particular, these operations may be performed by one or more processors of network device 10 (e.g., processing circuitry 12 in FIG. 1) using other components of network device 10 (e.g., memory circuitry 14, packet processor(s) 16, interfaces 18, etc., in FIG. 1). In some configurations described herein as an illustrative example, at least some of the operations described in connection with FIG. 9 may be performed by one or more processors (e.g., of processing circuitry 12) executing software instructions stored on memory circuitry (e.g., one or more non-transitory computer-readable storage media of memory circuitry 14). If desired, one or more operations described in connection with FIG. 9 may be performed in other manners by network device 10 or by other types of networking equipment.

At block 102, processing circuitry (e.g., processing circuitry 12, when executing the remote login process 48 in FIGS. 4 and 7) may verify a certificate chain that includes a login certificate and (trusted) certificate(s) identified by a login profile (e.g., certificate(s) 62 identified by login profile 46 as described in connection with FIGS. 5-7). In such a manner, the processing circuitry may verify the authenticity of the login certificate, establish trust in the login certificate, and use the login certificate for user identity authentication (e.g., as a verified login credential), e.g., in the illustrative manner described in connection with FIG. 7.

At block 104, the processing circuitry may check the revocation status of the login certificate based on a certificate revocation list identified by the login profile. In particular, the processing circuitry may check whether the login certificate is identified as a revoked (invalidated) certificate in the certificate revocation list, e.g., in the illustrative manner described in connection with FIG. 7.

At block 106, the processing circuitry may determine whether a login username matches subject name(s) in the login certificate based on a domain name omit setting (e.g., used in conjunction with the login profile). As an example, the operations at block 106 may be performed by performing at least some of the operations described in connection with FIG. 4.

At block 108, the processing circuitry may check a validity (e.g., a revocation status) of the login certificate with a certificate status check server (e.g., server 90 in FIG. 7) based on a server-based certificate status check profile identified by the login profile (e.g., profile 66 identified by login profile 46 as described in connection with FIGS. 5-7). As an example, the operations at block 108 may be performed by performing at least some of the operations described in connection with FIG. 7.

At block 110, after successfully validating the login certificate (e.g., based on performing one or more, or all, of the operations at blocks 102, 104, 106, and 108), the processing circuitry authorize login (e.g., the remote certificate-based login attempt) onto a network device. As an example, successfully validating the login certificate may include verifying the certificate chain beginning at the login certificate, determining that the login certificate is not in any certificate revocation lists, determining that the login certificate identifies the same user as the user associated with the login username, and/or determining that the login certificate is valid based on a certificate status check service provided by the certificate status check server (e.g., receiving an indication of login certificate validity from the server).

In some illustrative configurations sometimes described herein as an example, the operations described in connection with FIG. 9 may be performed after performing the operations described in connection with FIG. 8. This is merely illustrative. If desired, the operations described in connection with FIG. 8 and the operations described in connection with FIG. 9 may be performed independently from each other. If desired, one or more operations described in connection with FIG. 8 and/or FIG. 9 may be omitted. If desired, the order of the operations and/or blocks shown in FIG. 8 and/or FIG. 9 may be changed. If desired, some of the operations in different blocks shown in FIG. 8 and/or FIG. 9 may be performed at the same time.

Referring back to FIG. 7, an application such as a server-side remote login application (e.g., implemented by remote login process 48 executing on processing circuitry 24) may use server-based certificate status check profile 66 (e.g., as indicated by login profile 46) to check a validity of a user identity certificate obtained as part of the remote login operation by communicating with an external server such as server 90. In some scenarios, it may be desirable to communicate with the external server 90 using a virtual routing and forwarding (VRF) instance different from the VRF instance used for communication by the application (e.g., the remote login service).

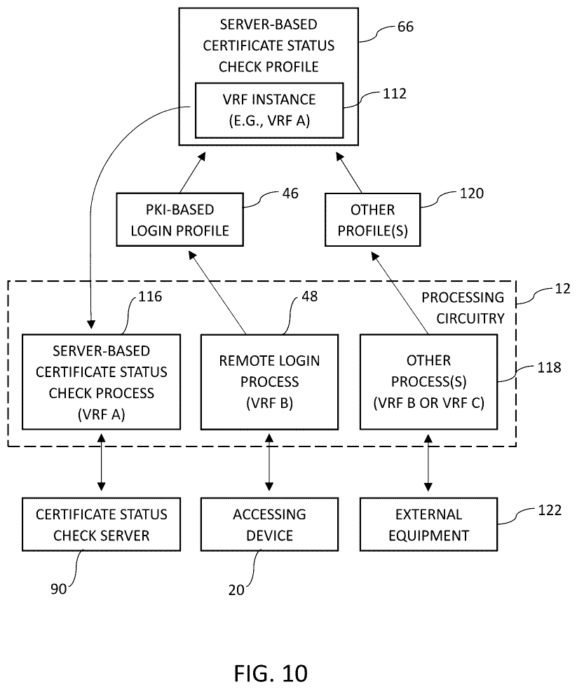

To facilitate communication with the certificate status check server using a specific VRF instance, certificate status check profile 66 may be configurable to include an indication of the specific VRF instance. FIG. 10 shows a diagram of network device operations (e.g., for device 10) based on server-based certificate state check profile 66 containing an indication 112 (e.g., an identifier or name) of the VRF instance (e.g., VRF A) used to communicate with certificate state check server 90 (e.g., in addition to or instead of the one or more other attributes or parameters for profile 66 described in connection with FIG. 5).

In particular, remote login process 48 (e.g., implementing a server-side application or service executing on processing circuitry 12 of device 10) may communicate with (e.g., listen for requests and other traffic from, transmit traffic to, etc.) accessing device 20 using a VRF instance (e.g., VRF B) to facilitate the remote login of device 20 onto device 10. In other words, traffic from (and to) accessing device 20 may be conveyed by processing circuitry 12 (and/or by packet processor(s) 16), when executing process 48, using a first routing table or other forwarding decision data for VRF instance VRF B and using a first set of interface(s) 18 for VRF instance VRF B.

Remote login process 48 may reference (e.g., indicate) login profile 46 (e.g., as described in connection with FIG. 5) to handle the remote login of device 20 onto device 10 in the manner specified by profile 46. Login profile 46 may itself reference (e.g., indicate) certificate state check profile 46 (e.g., as described in connection with FIG. 5 and containing an indication for VRF instance VRF A) to facilitate the validation process of a user identity certificate obtained from device 20. A server-based certificate status check process 116 (executing on processing circuitry 12) when used to communicate with server 90 to check the validation of the user identity certificate provided by accessing device 20 may use the VRF instance VRF A indicated by profile 66. In other words, traffic to and from server 90 may be conveyed by processing circuitry 12 (and/or by packet processor(s) 16), when executing process 116, using a second routing table or other forwarding decision data for VRF instance VRF A and using a second set of interface(s) 18 for VRF instance VRF A.

In such a manner, traffic for server-based certificate status check process 116 may be handled in a different VRF instance than traffic for remote login process 48.

If desired, profile 66 containing the indication for VRF instance VRF A may be shared amongst (e.g., indicated by) multiple profiles (e.g., multiple secure sockets layer (SSL) profiles, including login profile 46 which may be implemented in an SSL profile).

In the example of FIG. 10, in addition to profile 46, other profile(s) 120 (e.g., an SSL profile) may also reference profile 66 and may be used by other process(es) 118 (e.g., implementing a network device management application such as a server-side OpenConfig application, implementing other applications or services, etc.) executing on processing circuitry 12. Traffic from (and to) external equipment 122 may be conveyed by processing circuitry 12 (and/or by packet processor(s) 16), when executing process(es) 118, using the first routing table or other forwarding decision data for VRF instance VRF B and using the first set of interface(s) 18 for VRF instance VRF B, or using a third routing table or other forwarding decision data for VRF instance VRF C and using a third set of interface(s) 18 for VRF instance VRF C. In general, any number of VRF instances may be used and each may be shared by any number of processes.

Process(es) 118 may similarly desire server-based certificate validation operations provided by process 116. Because process(es) 118 also indicates profile 66, process 116 may similarly convey traffic for these additional certificate validation operations (e.g., for process(es) 118) using VRF instance VRF A.

Configured in the manner described in connection with FIG. 10, traffic between device 10 and server 90 may be handled in a separate VRF instance than other traffic (e.g., the traffic handled by processes 48 and 118). This may facilitate ease of management of these separate types of traffic.

The configuration and management of indication 112 of the VRF instance for profile 66 may be performed in a similar manner as described in connection with FIG. 6, in connection with the other attributes or parameters of profile 66.

The methods and operations described above in connection with FIGS. 1-10 may be performed by the components of one or more network devices, one or more computing devices, and/or one or more servers or other host equipment using software, firmware, and/or hardware (e.g., dedicated circuitry or hardware). Software code for performing these operations may be stored on one or more non-transitory computer-readable storage media (e.g., tangible computer readable storage media) on one or more of the components of the network device(s), the computing device(s), and/or the server(s) or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s), the computing device(s) and/or the server(s) or other host equipment.

The foregoing is merely illustrative and various modifications can be made to the described embodiments. The foregoing embodiments may be implemented individually or in any combination.

What is claimed is:

1. A network device comprising:
memory circuitry; and
processing circuitry coupled to the memory circuitry and configured to:
obtain input information indicative of a network device configuration for handling a certificate-based login onto the network device;
generate a login profile for validating a user identity certificate provided as part of the certificate-based login, the login profile identifying a public key certificate and one or more attributes based on the input information; and
store the login profile on the memory circuitry.

2. The network device defined in claim 1, wherein the public key certificate is a certificate trusted by the network device and usable to validate the user identity certificate.

3. The network device defined in claim 1, wherein the one or more attributes of the login profile comprise an attribute that identifies a certificate revocation list for determining whether the user identity certificate has been revoked by a certificate authority.

4. The network device defined in claim 1, wherein the processing circuitry is configured to:
generate a server-based certificate status check profile based on the input information; and
store the server-based certificate status check profile on the memory circuitry.

5. The network device defined in claim 4, wherein the one or more attributes of the login profile comprise an attribute that identifies the server-based certificate status check profile.

6. The network device defined in claim 5, wherein the server-based certificate status check profile contains information for communicating with a certificate status check server to determine a validity of the user identity certificate.

7. The network device defined in claim 6, wherein a location of the certificate status check server is identified in the server-based certificate status check profile or identified in the user identity certificate.

8. The network device defined in claim 4, wherein the server-based certificate status check profile includes a server request timeout attribute, a nonce value requirement attribute, or a certificate check requirement attribute.

9. The network device defined in claim 1, wherein the processing circuitry is configured to store a domain name omit setting based on which a login username provided as part of the certificate-based login and a subject name in the user identity certificate are compared.

10. A network device comprising:
memory circuitry configured to store a certificate status check profile and a login profile, the login profile identifying a public key certificate and identifying the certificate status check profile; and
processing circuitry coupled to the memory circuitry and configured to:
receive login credentials in connection with a remote login attempt for accessing the network device, the login credentials including a user identity certificate; and
validate the user identity certificate based on the login profile and based on the certificate status check profile.

11. The network device defined in claim 10, wherein the processing circuitry is configured to validate the user identity certificate based on the login profile by verifying a certificate chain that includes at least the user identity certificate and the public key certificate.

12. The network device defined in claim 10, wherein the processing circuitry is configured to validate the user identity certificate based on the certificate status check profile by communicating with a server based on the certificate status check profile to check a validity of user identity certificate.

13. The network device defined in claim 12, wherein the certificate status check profile includes an indication of a virtual routing and forwarding instance used by the processing circuitry to communicate with the server.

14. The network device defined in claim 10, wherein the login profile identifies a certificate revocation list and wherein the processing circuitry is configured to validate the user identity certificate by checking a revocation status of the user identity certificate using the certificate revocation list.

15. The network device defined in claim 10, wherein the login credentials include a login username and wherein the processing circuitry is configured to compare the login username to one or more subject names in the user identity certificate.

16. The network device defined in claim 10, wherein the login credentials are received using a secure shell protocol application executing on the processing circuitry.

17. A method of handling a certificate-based login attempt for remotely accessing a network device, the method comprising:
maintaining, by the network device, a domain name omit setting;
enabling, by the network device, the domain name omit setting;
receiving, by the network device, a login username and a login user identity certificate;
identifying, by the network device, a subject name in the login user identity certificate, the subject name including a domain name;
based on the domain name omit setting being enabled, comparing the login username with only a portion of the subject name to determine whether the login username matches the subject name; and
authorize the certificate-based login attempt based at least in part on the comparison.

18. The method defined in claim 17, wherein the subject name is a common name in the user identity certificate or is a subject alternative name in the user identity certificate.

19. The method defined in claim 17, wherein the compared portion of the subject name excludes the domain name.

20. The method defined in claim 17, wherein comparing the login username with only the portion of the subject name comprises:
identifying a given character in the subject name; and
comparing characters in the login username with characters in the subject name from the first character of the subject name up to the given character in the subject name.
